(19) United States
(12) Patent Application Publication
(10) Pub. No.: US 2016/0239278 A1
(43) Pub. Date: Aug. 18, 2016

(54) GENERATING A SCHEDULE OF INSTRUCTIONS BASED ON A PROCESSOR MEMORY TREE

(71) Applicant: Advanced Micro Devices, Inc., Sunnyvale, CA (US)

(72) Inventor: Shuai Che, Bellevue, WA (US)

(21) Appl. No.: 14/623,180

(22) Filed: Feb. 16, 2015

(51) Int. Cl. G06F 9/45

(52) U.S. Cl. CPC G06F 8/443

(57) ABSTRACT

A processor employs a memory tree and a code generation and scheduling framework (CGSF) to generate instructions to access data at memory modules associated with the processor. The memory tree is a data structure having a plurality of nodes, with each node corresponding to a different memory module, memory cluster, or other portion of memory. The CGSF employs the memory tree to expose the memory hierarchy of the processor to a computer programmer. The computer programmer can employ compiler directives to identify nodes of the memory tree and to establish data ordering and manipulation formats for each node. Based on the directives and the memory tree, the CGSF generates schedules of instructions that, when executed at the processor, enforce the data ordering and manipulation formats.

### BACKGROUND

1. Field of the Disclosure

The present disclosure relates generally to processors and more particularly to scheduling instructions at a processor.

2. Description of the Related Art

Modern processing systems are frequently tasked to execute operations while consuming a relatively small amount of power. One obstacle to these objectives in many processing systems is memory accesses. In particular, processing systems typically employ a memory hierarchy, wherein accesses to higher levels of the memory hierarchy take more time and consume more power than accesses to lower levels. Accordingly, to improve processing speed and reduce power consumption, computer programs sometimes aim for data locality so that repeated accesses to a given piece of data occur relatively close together in time (temporal locality) and different pieces of data that are likely to be accessed together are stored close together in the memory hierarchy (spatial locality). However, in some modern processing systems the memory hierarchy is formed of memory modules having disparate topologies. For example, the memory hierarchy can be composed of a combination of dynamic random access memory (DRAM), processor-in-memory (PIM modules), non-volatile storage, and active memory modules including integrated processing functionality. These disparate topologies can increase the difficulty of effectively employing data locality, and can also limit the benefits obtained from implementing data locality.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor and a code generation and scheduling framework to generate a memory tree for the processor in accordance with some embodiments.

FIG. 2 is a block diagram of the memory tree of FIG. 1 in accordance with some embodiments.

FIG. 3 is a diagram illustrating recursive scheduling of operations for different memory topologies at the processor of FIG. 1 in accordance with some embodiments.

FIG. 4 is a block diagram illustrating the compiler of FIG. 1 generating different recursive schedules for different memory topologies in accordance with some embodiments.

FIG. 5 is a flow diagram of a method of generating a schedule of machine instructions for execution at a processor based on a memory tree of the processor in accordance with some embodiments.

FIG. 6 is a flow diagram illustrating a method for designing and fabricating an integrated circuit device implementing at least a portion of a component of a processing system in accordance with some embodiments.

### DETAILED DESCRIPTION

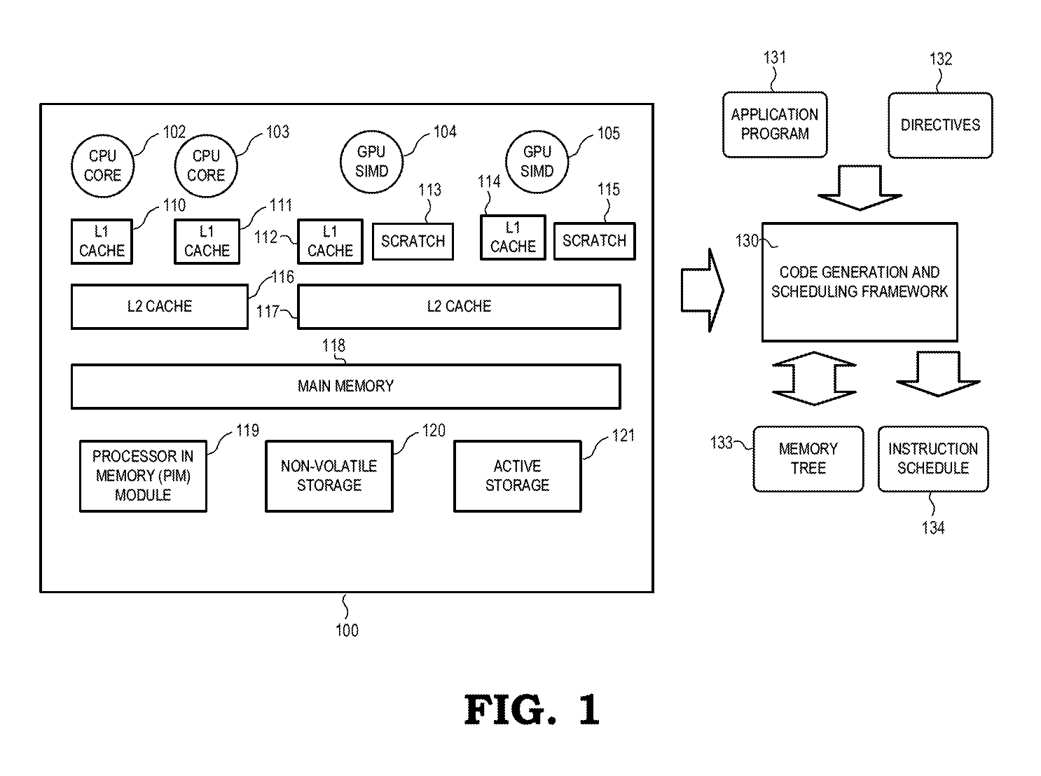

FIGS. 1-6 illustrate techniques for employing a memory tree and a code generation and scheduling framework (CGSF) to enhance processing efficiency at a processor employing memory modules of different topologies. The memory tree is a data structure having a plurality of nodes, with each node corresponding to a different memory module, memory cluster, or other portion of memory. The CGSF employs the memory tree to expose the memory hierarchy of the processor to a computer programmer or otherwise allow a program to access different memory modules in different ways. For example, the computer programmer can employ compiler directives to identify nodes of the memory tree and to establish data ordering and manipulation formats for each node. Based on the directives and the memory tree, the CGSF generates schedules of instructions that, when executed at the processor, enforce the data ordering, decomposition, and manipulation formats. This allows the computer programmer to ensure that data is organized and manipulated more efficiently at the memory hierarchy, improving overall processing efficiency.

To illustrate via an example, a processor may employ a memory hierarchy with memory modules of two different topologies. For purposes of the example, the memory modules of one topology are designated Memory A and the memory modules of the other topology are designated Memory B. The topology of Memory A is such that an array of data at the memory can be accessed more efficiently if the data is organized into relatively small portions (referred to as “chunks”) and is accessed in a row-major format. In contrast, the topology of Memory B is such that an array of data at the memory can be accessed more efficiently if the data is organized into larger chunks and is accessed in a column-major format. In some embodiments, the most efficient way to organize and access data at a given memory may not depend, or depend only, on the topology of the memory but instead be governed by the type of processing module (e.g., CPU or GPU) accessing the memory, on the multithreaded model used to access the memory, and the like. Conventionally, the factors that govern the most efficient way to organize and access data at Memory A and Memory B are not visible to a programmer. Accordingly, the programmer writes standard instructions to access data arrays without regard to these factors. A compiler generates machine instructions based on the standard instructions to access the data arrays at each memory according to the conventions of the compiler. For example, the compiler may be configured so that the instructions generated to access data arrays is such that data arrays are always accessed in relatively small chunks, using a column-major format. The machine instructions generated by the compiler therefore do not access either Memory A or Memory B efficiently.

In contrast, with the techniques disclosed herein, the memory tree and CGSF allow the programmer, or the CGSF itself, to control how the compiler generates machine instructions so that both Memory A and Memory B can be accessed more efficiently. For example, the programmer can provide compiler directives indicating, for one or more nodes of the memory tree, how data is to be organized, decomposed, and accessed at the corresponding memory modules. Based on these directives, the compiler generates a schedule of machine instructions to access each memory module as indicated in the corresponding directive. Thus, under the example above, the programmer can provide directives indicating that the node of the memory tree corresponding to Memory A is to be organized into relatively small chunks with a particular size and accessed in a row-major format. The programmer can further provide a directive indicating that the node of the memory tree corresponding to Memory B is organized into larger chunks and is accessed in a column-major format. During compilation or runtime of a program, the CGSF identifies accesses to data arrays in the program and identifies where each data array (or portion of a data array) is stored. The CGSF generates a schedule of machine instructions, for execution at the processor, that access each data array (or portion thereof) according to the corresponding directive provided by the programmer, or based on analysis of the code by the CGSF to identify how each memory module is to be accessed. Thus, data arrays at memories of different topologies are accessed in the most efficient way for that data array, thereby enhancing processor efficiency. In some embodiments, rather than using directives to indicate the most efficient way to access data at each memory module, the CGSF itself automatically analyzes the memory topologies associated with the processor, the architecture of the processor cores and other processing modules, the multithreaded model employed by the processor, and other factors to determine the most efficient way to access data at each memory module. The CGSF then automatically generates the schedule of machine instructions based on this analysis.

FIG. 1 illustrates a block diagram of a processor 100 in accordance with some embodiments. The processor 100 can be a general purpose processor, a special purpose processor, or application specific processor embedded in any of a number of electronic devices, including a personal computer, server, game console, compute-enabled cell phone, tablet, and the like. The processor 100 is generally configured to execute sets of instructions organized and stored as computer programs to perform operations specified by those sets of instructions. To facilitate execution of the sets of instructions, the processor 100 includes central processing unit (CPU) cores 102 and 103 and graphics processing unit (GPU) single-instruction multiple-data units (SIMDs) 104 and 105. The CPU cores 102 and 103 each include one or more instruction pipelines to execute specified instructions. For purposes of description, the instructions of a computer program as prepared by a programmer are referred to as program instructions and the instructions used by the instruction pipelines are referred to as machine instructions. As described further herein, the program instructions are translated to machine instructions by a CGSF.

The GPU SIMDs 105 and 106 are processing modules generally configured to execute machine instructions associated with graphics, video, display operations, and general-purpose computation. In some embodiments the machine instructions executed by the GPU SIMDs 104 and 105 are generated directly from program instructions. In some embodiments the operations of the GPU SIMDs 104 and 105 are managed and controlled by instructions executing at the CPU cores 102 and 103.

The processor 100 includes a number of memory modules, including L1 caches 110, 111, 112, and 114, scratchpads 113 and 115, L2 caches 116 and 117, main memory 118, processor-in-memory (PIM) module 119, non-volatile storage 120, and active storage module 121. Each of the memory modules 110-121 has an associated topology, defined by the memory hardware that composes the memory module. For example, in some embodiments, the L1 caches 110, 111, 112, and 114, the scratchpads 113 and 115, and the L2 caches 116 and 117 are all composed of static RAM (SRAM) modules and the main memory 118 is composed of DRAM modules. The PIM module 119 includes DRAM modules and one or more processors to execute memory operations (e.g., error detection and correction, memory controller operations, memory organization operations, encryption and decryption, memory-intensive portions of programs offloaded from the CPU, and the like). The non-volatile storage 120 includes flash memory, hard disc drives, solid state drive (SSD) memory modules, and the like, or a combination thereof. The active storage module 121 includes storage devices (e.g., flash or disk drives) memory buffers, and processing modules to perform one or more operations (e.g., memory controller operations, memory-intensive portions of programs offloaded from a CPU). In some embodiments, the non-volatile storage 120 is part of the active storage module 121. In some embodiments, the topology can also differ between modules of the same general memory type. For example, the L2 caches 116 and 117 can be composed of DRAM modules having a different topology (e.g., a different number of transistors for each memory cell, different column and row selection hardware, and the like) than the DRAM modules of the main memory 118.

For purposes of description of FIG. 1, it is assumed that the topology of a memory module generally governs the most efficient way to store and access data at the memory module. For example, a memory module of a given topology may be most efficiently accessed when data to be accessed in succession (e.g., by a succession of memory access requests to the memory module) is accessed in chunks of a particular size and in a column-major format. A memory module of a different topology may be most efficiently accessed when data to be accessed in succession is accessed in chunks of a different size and in a row-major format. It will be appreciated that in some embodiments the most efficient way to access data at a memory module may be affected by other factors, including the processor architecture and multithreaded model employed by a processing module. For example, a GPU SIMD may access data more efficiently when data is stored in a particular layout, while a CPU accesses the data more efficiently when data is stored in a different layout. The processor 100 employs a code generation and scheduling framework (CGSF) 130 to generate machine instructions so that each memory module, or group of memory modules, is accessed according to the more efficient way to access data for that memory module, processor architecture, multithreaded model, and other access efficiency factors, thereby improving processing efficiency.

The CGSF 130 is a set of routines, libraries, compiler modules, and tools that collectively translate an application program 131 to an instruction schedule 134. The application program 131 is a set of program instructions prepared by a programmer to carry out specified operations, such as data processing, graphics display, video compression, word processing, network operations, and any other operation that can be carried out at the processor 100. The instruction schedule 134 is a set of machine instructions arranged in a particular order, or schedule, so that when the machine instructions are executed at the processor 100 the operations defined by the application program 131 are carried out.

To allow the programmer of the application program 131 to control how the data in different memory modules of the processor 100 are accessed, the CGSF 130 generates a memory tree 135. The memory tree 135 is a data structure including a plurality of nodes, with each node of the tree corresponding to a different memory module or combination thereof. For example, in some embodiments the memory tree 135 includes a different node for each of the memory modules 110-121. In some embodiments the CGSF 131 generates the memory tree 135 based on configuration information for the processor 100 that indicates the memory modules used by the processor 100. This configuration information may be stored at, for example, the non-volatile storage 120 and read by the CGSF 130 to generate the memory tree 135. In some embodiments, the configuration information can be constructed and initiated by system software and stored in memory for programs to read and use. In some embodiments each node of the tree stores information about the corresponding memory module, such as the type of memory, size of the memory module, number of banks of the memory module, line size of the memory module, and other parameters.

To control how data at each memory module is accessed, the programmer prepares CGSF directives 132. One or more of the CGSF directives indicates, for a given node of the memory tree 135, how data at the corresponding memory module is to be organized and accessed. To illustrate via an example, one of the CGSF directives 132 can read as follows:
#pragma MemTreeCGSF partition(array 1[0:m] [0:n]) NODE1((256, 256), row-major)
   This directive indicates that for a node of the memory tree 135 designated “NODE1”, arrays stored at the memory module corresponding to NODE1 are to be organized into 256×256 chunks of a given data type, and the chunks are to be accessed in a row-major order. For a different node, the CGSF directives 132 can include a directive as follows:
#pragma MemTreeCGSF partition(array2[0:m][0:n]) NODE2((64, 128), column-major)
   This directive indicates that for a node of the memory tree 135 designated “NODE1”, arrays stored at the memory module corresponding to NODE1 are to be organized into 64×128 chunks, and the chunks are to be accessed in a column-major order.

In operation, as the CGSF 130 uses the CGSF directives 132 to determine how the instruction schedule 134 is to be generated so that the resulting schedule of machine instructions accesses data at the memory modules of the processor 100 as indicated by the directives. To illustrate using the example directives above, the CGSF 130 can analyze the application program 131 to determine that an array, designated array1, is to be created. Further, the CGSF 130 determines that, at a given point in the program flow, the application program 131 requires that each element of array1 is to be increased by a value of one. The CGSF 130 determines that, at this point in the program flow, array1 is stored at the memory module corresponding to NODE1. Accordingly, the CGSF 130 generates the machine instructions of the instruction schedule 134 so that array1 is accessed at the memory module in 256×256 chunks in a row-major order, as indicated by the directive for NODE1. In some embodiments, the CGSF 130 analyzes the code of the application program 131, the memory module topologies, and other factors and itself determines the chunk size, the order of access, and the like, so that the programmer does not have to provide directives to indicate this information.

The CGSF 130 can further determine that, at a different point in the program flow, array1 is to be accessed when it is stored at the memory module corresponding to NODE2. Accordingly, for this access the CGSF 130 generates the corresponding machine instructions of the instruction schedule 134 so that array1 is accessed in 64×128 chunks in a column-major order, as indicated by the directive for NODE2. Thus, the machine instructions of the instruction schedule 134 are tailored to access the memory modules of the processor 100 as indicated by the corresponding directives. These directives can be configured so that each memory module is accessed in a manner that is most efficient for the corresponding topology, thereby improving processing efficiency.

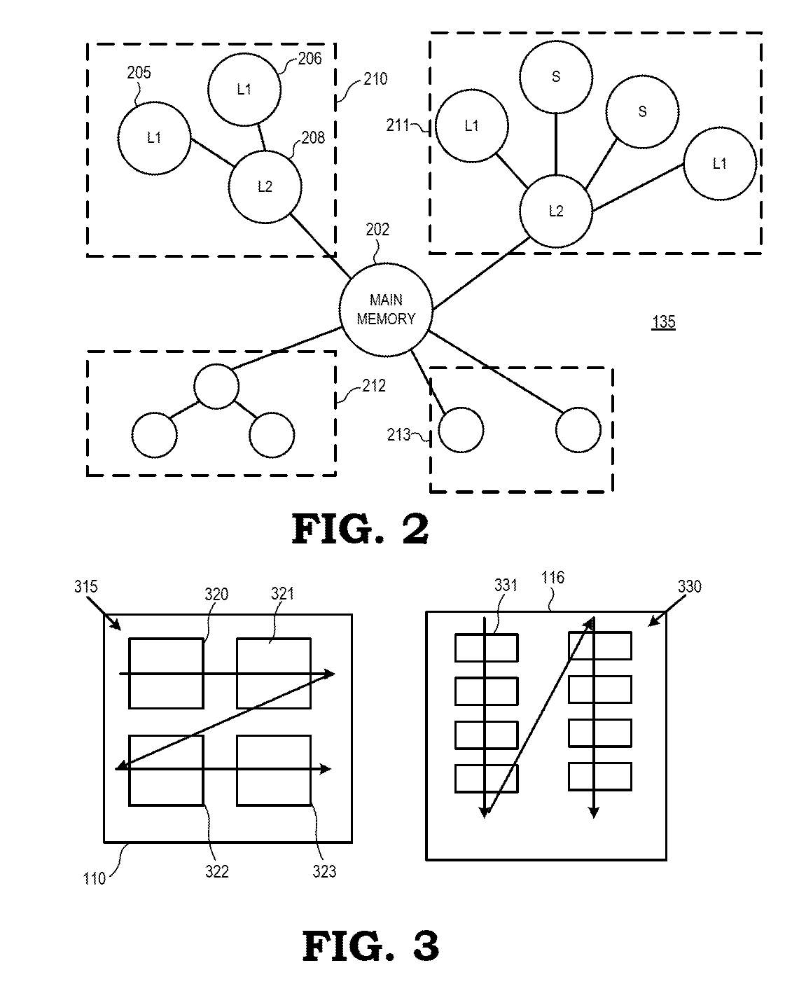

FIG. 2 illustrates the memory tree 135 of FIG. 1 in accordance with some embodiments. The memory tree 135 includes a number of nodes (e.g., nodes 202, 205, 206, and 207) with each node corresponding to a different portion of memory for the processor 100. In the illustrated example, the node 202 corresponds to main memory 118, node 205 corresponds to the L1 cache 110, node 206 corresponds to the L1 cache 11, and node 207 corresponds to the L2 cache 116. The nodes of the memory tree 135 can be grouped into clusters, such as clusters 210, 211, 212, and 213. Each cluster represents the memory modules associated with a given portion of the processor 100. For example, cluster 210 includes the nodes corresponding to the memory modules employed by the CPU cores 102 and 103, cluster 211 includes the nodes corresponding to the memory modules employed by the GPU SIMDs 104 and 105, cluster 212 includes the nodes of the memory modules of the PIM module 119, and cluster 213 includes the memory modules of the active storage module 121. Each node can also store information about the memory modules corresponding to the node, such as the type of memory, size of the memory modules (e.g., line size, number of banks), and the like. In some embodiments, each node can also store pointers that can be used by the set of instructions generated by the CGSF 130 to access data at the corresponding memory module.

In some embodiments, the CGSF directives 132 (FIG. 1) can identify one or more nodes of the memory tree 135 by node identifier, cluster identifier, or at another level of granularity. For each directive of the CGSF directives 132, the CGSF 130 identifies the node, or set of nodes (e.g., cluster of nodes) indicated by the directive. The CGSF 130 then uses the organization and access constraints indicated by the directive to ensure that accesses to data at the memory modules corresponding to the nodes comply with the indicated constraints. The memory tree 135 thus exposes the different memory modules of the processor 100 to the programmer of the application program, or the compiler and the runtime to make appropriate code generation and scheduling decisions. This allows applications to access data at the different memory modules efficiently. Moreover, because the CGSF 130 generates the instruction schedule 134 based on the directives, or its own automatic analysis, and the memory tree, the programmer is not required to manage accesses to the different memory modules at a low level, enhancing programming efficiency.

FIG. 3 illustrates a block diagram of an example of the CGSF 130 generating different recursive instruction schedules for different memory modules of the processor 100 in accordance with some embodiments. In the illustrated example of FIG. 3 the main memory 118 stores a data array 315 and the L2 cache 116 stores a data array 330. In some embodiments, the data array 315 and data array 330 may be portions of a larger data array generated or manipulated by the application program 131. In some embodiments, the data array 315 and the data array 330 may be different data arrays manipulated by the application program 131.

For purposes of the example of FIG. 3, it is assumed that the CGSF directives 132 include a directive indicating that arrays at the main memory 118 are to be accessed in 256×256 chunks, in a row-major order. The 256×256 chunk is the size of data to be loaded into the L2 cache 116. In addition, it is assumed that the CGSF directives 132 include a directive indicating that arrays at the L2 cache 116 are to be accessed in 64×128 chunks (⅛ of a 256×256 chunk) in a column-major order. The 64×128 chunk is the size of data loaded into the L1 cache 110. During compilation or runtime of the application program 131 the CGSF 130 determines that array 315 is to be accessed at the main memory 118 by the application program 131. In response, the CGSF 130 generates the instruction schedule 134 so that the array 315 is decomposed into four 256×256 chunks 320, 321, 322, and 323. The CGSF 130 further generates the instruction schedule to include instructions that access the chunks 320-323 in row major order, so that chunk 320 is accessed first, followed by chunk 321, followed by chunk 322 (in the next row), and ending with chunk 323. Each 256×256 chunk will be accessed and loaded into the L2 cache 116 in a row-major order. Similarly, each 256×256 chunk (array 330) in L2 will be further decomposed into eight 64×128 chunks, each of which will be accessed and loaded into the L1 in a column-major order. In some embodiments, because each chunk is to be accessed and manipulated in the same way, the CGSF 130 generates a recursive schedule for the chunks 320-323, wherein the recursive schedule includes a set of machine instructions that are recursively applied to each of the chunks 320-323 in row-major order and similarly to the chunks in the L2 cache 116 in column-major order. Thus, the instruction schedule 134 includes machine instructions that access arrays, or portions of the same array, at the main memory 118 and the L2 cache 116 differently based on the CGSF directives 132. This allows a programmer, through the use of appropriate directives, to ensure that data at each memory module, or collection thereof, of the processor 100 is accessed in the most efficient way according to the topology of the memory module, thereby improving processing efficiency.

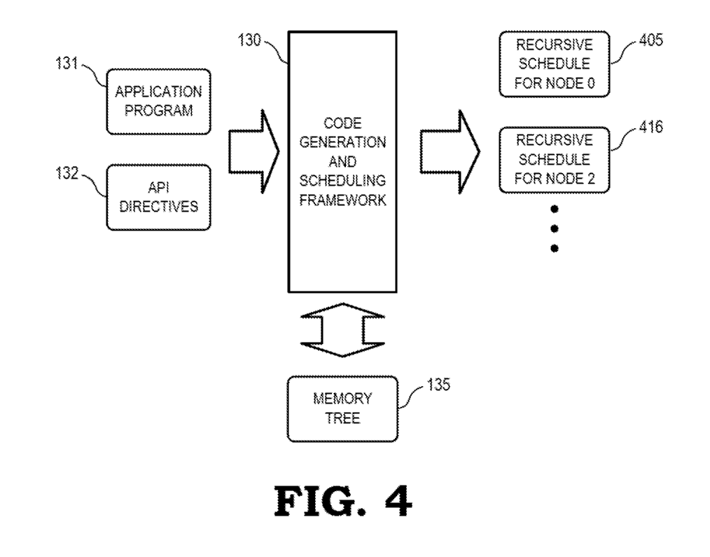

FIG. 4 illustrates a block diagram of an example of the CGSF 130 generating different recursive schedules for different nodes of the memory tree 135. In the example of FIG. 4, the CGSF 130 generates the memory tree 135 to include nodes for different memory modules of the processor 100, as described above. The CGSF 130 then analyzes the CGSF directives 132 to identify any directives that indicate how the memory modules for a particular node of the memory tree 135 are to be accessed. In some embodiments, if the CGSF directives 132 do not include a directive for a given node, the CGSF 130 employs a specified default mode of access for the memory modules of the given node or generates a strategy by analyzing program 131 and hardware information of a particular tree node.

The CGSF 130 analyzes the application program 131 to identify accesses to data. In response to identifying a data access, the CGSF 130 identifies which memory modules store the data when it is accessed and identifies the node of the memory tree 135 corresponding to the identified memory modules. The CGSF 130 determines the mode of access to the node as indicated by the CGSF directives 132 and generates a recursive schedule of machine instructions to access the data as indicated by the corresponding directive. The CGSF 130 thereby generates different recursive schedules for different nodes of the memory tree 135. For example, the CGSF 130 generates recursive schedule 405 for NODE0 of the memory tree 135, recursive schedule 406 for NODE1 of the memory tree 135, and so on until all necessary recursive schedules of machine instructions have been generated. The recursive schedules of machine instructions are executed by the processor 100 to carry out the data accesses indicated by the application program 131.

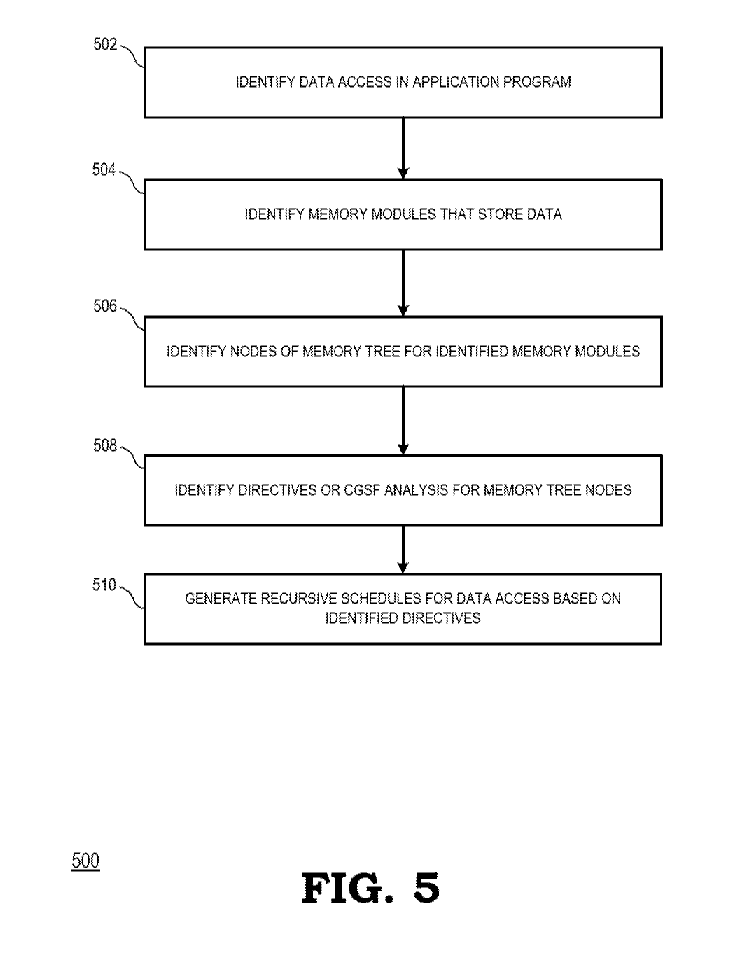

FIG. 5 illustrates a flow diagram of a method 500 of generating a schedule of machine instructions for the application program 131 in accordance with some embodiments. At block 502 the CGSF 130 identifies a data access in the application program 131. At block 504 the CGSF 130 identifies the memory modules of the processor 100 that store the data to be accessed. At block 506 the CGSF 130 identifies the nodes of the memory tree 135 that correspond to the memory modules identified at block 504. At block 508 the CGSF 130 analyzes the compiler directives 132 to identify any directives for the nodes identified at block 506. At block 510 the CGSF 130 generates recursive schedules for the data access so that the data at each memory module is accessed according to the scheme indicated by the directives or by analysis of the application program by the CGSF 130.

In some embodiments, the apparatus and techniques described above are implemented in a system comprising one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

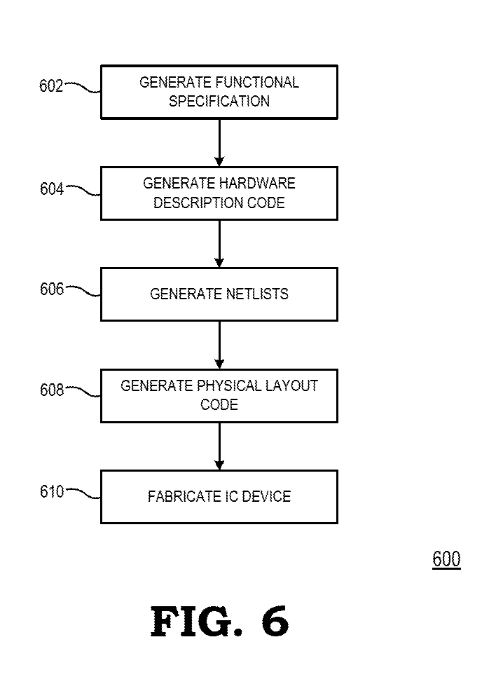

FIG. 6 is a flow diagram illustrating an example method 600 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating, at a processor, a memory tree identifying memory modules employed by the processor; and
generating and storing, at the processor, a schedule of machine instructions for execution based on the memory tree.

2. The method of claim 1, wherein the memory tree comprises a plurality of nodes, each of the plurality of nodes associated with a different set of memory modules employed by the processor.

3. The method of claim 2, wherein:
generating the schedule of machine instructions comprises generating the schedule of machine instructions based on one or more directives indicating how data at one or more corresponding memory modules of the processor is to be accessed.

4. The method of claim 3, wherein the one or more directives includes:
a first directive indicating first data at a first set of memory modules is to be accessed according to a first block size; and
a second directive indicating second data at a second set of memory modules is to be accessed according to a second block size, the second block size different from the first block size.

5. The method of claim 3, wherein the one or more directives includes:
a first directive indicating first data at a first set of memory modules is to be accessed according to a first format; and
a second directive indicating second data at a second set of memory modules is to be accessed according to a second format different from the first.

6. The method of claim 2, wherein:
generating the schedule of machine instructions comprises generating the schedule of machine instructions based on an analysis by a compiler identifying how data at one or more corresponding memory modules of the processor is to be accessed.

7. The method of claim 1, wherein the memory tree comprises a plurality of nodes, each of the plurality of nodes storing information indicating characteristics of a memory module corresponding to the node.

8. The method of claim 7, wherein each of the plurality of nodes stores pointer information to be used to access data at the memory module corresponding to the node.

9. A method, comprising:
receiving, at a processor, a plurality of directives indicating corresponding data access formats for memory modules employed by the processor; and
generating and storing, at the processor, based on the plurality of directives, a schedule of machine instructions to access data at the memory modules according to the data access formats.

10. The method of claim 9, further comprising:
generating a memory tree at the processor, the memory tree comprising a plurality of nodes corresponding to the memory modules; and
generating the schedule of machine instructions based on the memory tree.

11. The method of claim 10, wherein the memory tree comprises a plurality of nodes, each of the plurality of nodes associated with a different set of memory modules employed by the processor.

12. The method of claim 9, wherein the plurality of directives includes:
a first directive indicating first data at a first set of memory modules is to be accessed according to a first block size; and
a second directive indicating second data at a second set of memory modules is to be accessed according to a second block size, the second block size different from the first block size.

13. The method of claim 9, wherein the plurality of directives includes:
a first directive indicating first data at a first set of memory modules is to be accessed according to a first format; and
a second directive indicating second data at a second set of memory modules is to be accessed according to a second format different from the first format.

14. A non-transitory computer readable medium storing instructions to be executed at a processor, the instructions, when executed, to manipulate the processor to:
generate a memory tree indicating memory modules employed by the processor; and
generate a schedule of machine instructions for execution at the processor based on the memory tree.

15. The computer readable medium of claim 14, wherein the memory tree comprises a plurality of nodes, each of the plurality of nodes associated with a different set of memory modules employed by the processor.

16. The computer readable medium of claim 15, wherein:
the instructions to generate the schedule of machine instructions comprise instructions to generate the schedule of machine instructions based on one or more directives indicating how data at one or more corresponding memory modules of the processor is to be accessed.

17. The computer readable medium of claim 16, wherein the one or more directives includes:
a first directive indicating first data at a first set of memory modules is to be accessed according to a first block size; and
a second directive indicating second data at a second set of memory modules is to be accessed according to a second block size, the second block size different from the first block size.

18. The computer readable medium of claim 16, wherein the one or more directives includes:
a first directive indicating first data at a first set of memory modules is to be accessed according to a first format; and
a second directive indicating second data at a second set of memory modules is to be accessed according to a second format different from the first.

19. The computer readable medium of claim 18, wherein the first data and the second data are portions of a same data array of an application program.

20. The computer readable medium of claim 16, wherein the first set of memory modules are of a first level of a memory hierarchy of the processor and the second set of memory modules are of a second level of the memory hierarchy different from the first level.
